(19) United States
(12) Patent Application Publication
(10) Pub. No.: US 2003/0110070 A1
(43) Pub. Date: Jun. 12, 2003

(54) Method, framework and system for organizing, aligning and managing organizations

(76) Inventor: Marc Alexander De Goeij, Amsterdam (NL)

Correspondence Address: Michaelson & Wallace, Parkway 109 Office Center, 328 Newman Springs Road, PO Box 8489, Red Bank, NJ, 07701, US

(21) Appl. No.: 10/258,691

(22) PCT Filed: Feb. 5, 2001
(86) PCT No.: PCT/NL01/00087

(51) Int. Cl. G06F 17/60; G06F 9/00

(52) U.S. Cl. 705/8; 709/106

(57) ABSTRACT

A concept and method for organizing and aligning processes, functions, roles and tasks within organizations and across organizations by dividing these into Front Offices covering all processes, functions, roles and tasks whereby only the interaciton with any outside party, including Customers, is involved and Back Offices covering all processes, functions, roles and tasks whereby only the execution of a service or the production of a product is involved. Between the Front Offices and the Back Offices a Mid-Office is introduced covering all processes, functions, roles and tasks related to the coordination and management of all processes, functions, roles and tasks within or across organizations over all relevant Front Offices and Back Offices.

### INTRODUCTION: REFERENCE TO U.S. Pat. No. 6,101,479 AND BACKGROUND OF THE INVENTION

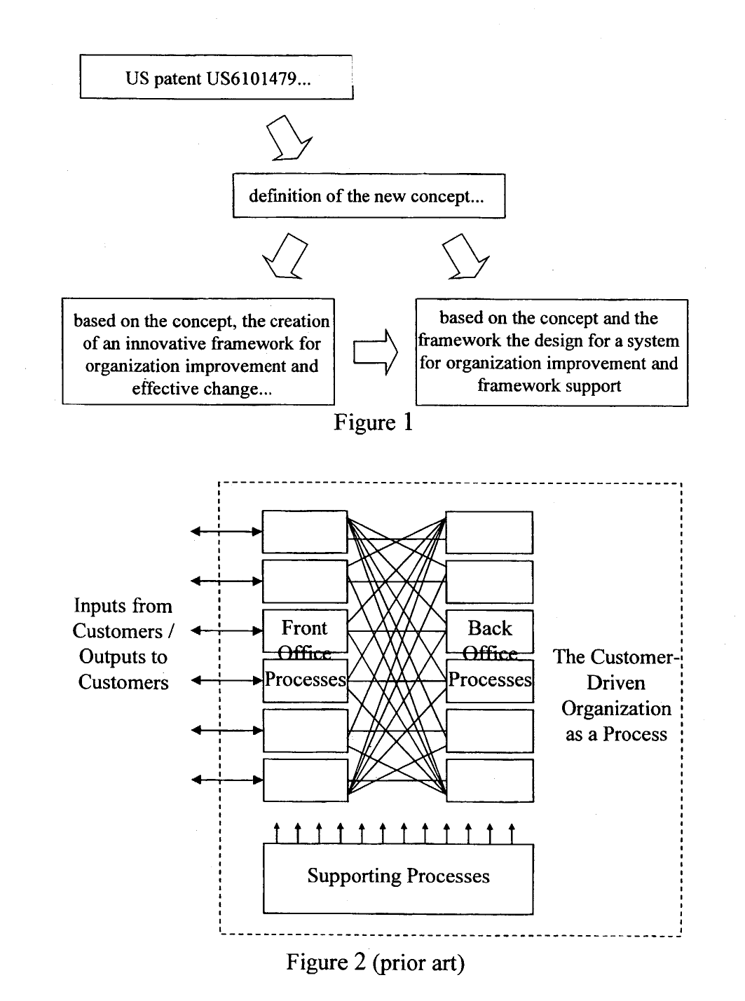

The description in this document will follow a build-up that is illustrated by FIG. 1. Based on prior art notions from U.S. Pat. No. 6,101,479 a concept is defined that deals with a specific organizational problem not resolved yet. Based on this concept, a framework is defined, that may be used to help organizations to improve their quality. This framework can be used as is, but can also be supported by the implementation of a system, an integrated software/hardware solution that may be implemented in order to help organizations to improve their quality in an automated way. The framework and the system will both jointly and separately be claimed here.

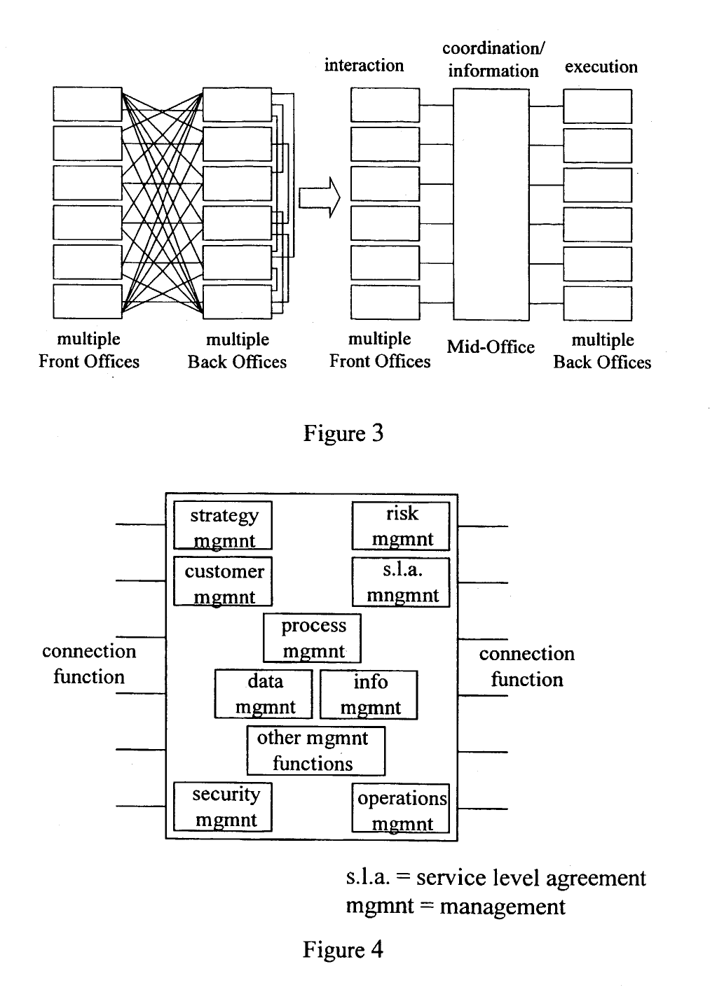

U.S. Pat. No. 6,101,479 describes an organization in terms of Macro processes or high level processes that may be composed of multiple sub-processes. According to this patent, Front Office processes are defined as the sub-processes of a Macro process that interact directly with the organization's primary Customers, Back Office Processes are defined as the sub-processes of a Macro process that do not interact directly with the organization's Customers and Supporting processes are defined as being shared between Macro processes; they are identifiable by the fact they interact with almost all other processes in the organization. U.S. Pat. No. 6,101,479 FIG. 3 published in said U.S. patent views the organization as a process with inputs from Customers, outputs from Customers, where the inputs are transformed into outputs by the so-called Customer-Driven Organization as a Process which also shows Supporting Processes which apparently support all other processes. Another way to depict these different types of processes is illustrated in FIG. 2, where inputs from Customers and outputs to Customers are positioned left from the Customer-Driven Organization as a Process according to the prior art idea where all interaction takes place through Front Office processes in the organization. The ideas in said patent try to resolve the relationship between process performance and resource allocation to the most important processes, most important in this respect based on a prioritization of importance through Customer perception. However, the above invention does not resolve the complexity that exists between multiple Front Office processes and multiple Back Office processes and multiple Supporting processes in organizations and the coordination of all those processes within or across organizations. In order to resolve this, a new ‘Office’ must be introduced; the need for such an Office, its content and its application will be described in this document. In Appendix A, the discriminatory differences between U.S. Pat. No. 6,101,479 and the current invention are described.

Background of the invention is based on the current business context: a world becoming more global and more complex. Organizations go across geographic regions in offering their products and services. The introduction and growth of the internet has significantly supported this trend of globalization. It is now easier than ever to reach customers in geographic areas were no physical representation is located. Borders become less relevant; more and more cross-border mergers and acquisitions take place. It is not enough to be international, i.e. to be present in many markets and satisfy the local market: global customers require global consistent services in all geographic regions. Customers now desire the same product, service or ‘look-and-feel’ from whatever angle they look at the organization (irrespective geographic location and channel used).

Organizations are also facing shrinking business cycles: product life cycles, or even organization life cycles get shorter and shorter. Organizations must not only be able to continuously renew existing products and services and have a fast time-to-market for new products and services, but they also have to continuously renew themselves. In fact, they must have adaptability as a most critical factor for their organization design.

In the meantime, industries are consolidating. This is either to obtain synergy, to complete a product offering (for instance merging access with content), to achieve economies of scale or to gain access to other markets (cross-border mergers). Autonomous growth in some areas just goes too slow to justify the huge investments necessary. On the other hand, an almost opposite tendency exists: outsourcing. Organizations realize more and more that they can become more effective and more efficient by outsourcing part of their processes to other organizations. This is often very effective, where the outsourcing organization (the outsourcer) outsources a supporting process that is the core process of the insourcing organization (the insourcer), which usually allows them to do it better, cheaper and faster. In this way, more extended value chains of organizations start to exist. Functions become more specialized, which is often good for the quality and the price of products and services, but bad for overseeing the big picture, the whole process or the whole value chain. Organizations who will succeed in overseeing this value chain will be able to influence and manage that value chain, and will become leaders.

Customers of organizations become more demanding; they require more and better services; their loyalty is only bought by extreme customer focus. This tendency translates in a pull for more personalized products and services which forces organizations to mass-customize their offering and seems to throw the mass-production models overboard. In practice, a combination of both remains necessary, as mass-customization is necessary to support differentiation and mass-production is necessary to reduce cost price in markets of rapidly commoditizing products in order to be able to secure a profit margin. The old model of produce, store and sell is replaced by the model of production on demand. This requires organizations to be more flexible in their production lines. Next to becoming more demanding, customers also become better informed (also by the influence of the internet). By improved confidence based on their increased knowledge, customers start by-passing intermediaries that used to dominate processes. Information brokers—such as insurance writers or real estate brokers—now become obsolete by lack of value-add in the new model of dis-intermediation: customers find suppliers at the source right away. Because of this, however, customers can get overwhelmed by the information overload and the global product offering currently within reach. This allows for new entrants with new business models (based on re-intermediation), becoming information filters or transaction brokers, such as search engines and market places. In this way, existing business models are completely reshaped. By the introduction of E-commerce, organizations need to be able to quickly adapt new business models and to market and deliver their products and services through more and more channels.

Finally, increasing trends of deregulation in many countries and industries allow new entrants to come in and change business models or force old contenders to become more flexible and agile. Or the other way around, new regulations, or some reinforced existing ones—such as forcing separation of front offices and back-office functions in organizations—force organizations to change their internal processes as well.

In summary it seems that organizations can only cope with the above trends by getting ready for continuous change. The most adaptive and organizations will prove to be the most sustainable.

### SHORT DESCRIPTION OF THE INVENTION

The invention relates in general to a prior art concept and method for organizing and aligning processes, functions, roles and tasks within organizations and across organizations by separating within or across organizations:

a number of Front Office processes which are the sub-processes of Macro processes that interact directly with the organization's primary Customer(s),

a number of Back Office which are the sub-processes of Macro processes that do not interact with the organization's Customers, and

a number of supporting processes that are shared between Macro processes and normally doesn't directly impact the Customer's perception of the quality of an organizational output.

This concept can be applied for organizing business operations in organizations which have to deal on the one hand with Customers (in a very broad sense, including other third parties) who require from the organization to perform a predetermined task and on the other hand with further organizations or humans who have to perform one or more tasks. In practice there could be many Customers (many thousands in case of a larger organization) and many task performers (many thousands in larger organizations) grouped in many organizational units (many hundreds in larger organizations). It will be clear that managing such an organization in an optimum manner whereby all Customers are satisfied and all task performers are able to perform their tasks effectively and efficiently, is a challenge.

An attempt to streamline the organization is described in U.S. Pat. No. 6,101,479 wherein the method and concept described in the first paragraph above is published. This is where the idea of separating Front Offices and Back Offices is proposed. According to this idea the organization is divided into two sections, the one section, called the Front Office, covering all tasks whereby interaction with the Customer is involved and whereby the request of the Customer is defined, and an other section, called the Back Office, covering tasks whereby no communication with the Customers is required. The introduction of a Front Office and a Back Office leads to a distinction between tasks to perform and leads to an improvement of the functioning of the organization. However, in practice it appears that with this proposal not all problems are over. Especially the communication between Front Offices and Back Offices may cause many problems. Furthermore, maintaining data integrity is rather awkward. An object of the invention is now to improve the above indicated prior art method and to indicate how an organization can be structured and supported far more effectively by a method and framework for organization improvement and management and by a supporting integrated software/hardware solution.

In agreement with said object the invention now provides a method in principle according to the first paragraph which is characterized in that

Front Offices cover all processes, functions, roles and tasks whereby only interaction with the Customer is involved;

Back Offices cover all processes, functions, roles and tasks whereby only execution is involved in that a service is executed or a product is produced;

between Front Offices and Back Offices one Mid-Office is introduced covering all processes, functions, roles or tasks related to the coordination and communication between any Front Office and any Back Office and storing or maintaining centrally data and information about all relevant organizational internal and external items necessary for proper performing of said processes, functions, roles and tasks,

hereafter often referred to as the Front Office/Mid-Office/Back-Office concept, the FMB concept or simply the Mid-Office concept.

The invention is not only related to a concept and method but also to a framework and method for implementing the concept based on an integrated architecture which is separated into the following four layers:

a first architecture layer or blueprint of the processes, functions, roles and tasks within or across organizations, aligned with the objectives of those organizations (the Business Architecture layer),

a second architecture layer or blueprint of the information flows and data elements necessary to support the above mentioned processes, functions, roles and tasks (the Information Architecture layer),

a third architecture layer or blueprint of the applications and software systems necessary to support the above mentioned processes, functions, roles and tasks and supporting information flows and data elements (the Application Architecture layer)

a fourth architecture layer or blueprint of the hardware systems, operating systems and networks necessary for the above mentioned applications and software systems to run on (the Technology Architecture layer),

whereby each of the above mentioned architecture layers is constructed according to the previously explained FMB concept and the whole integrated set of four architectures hereafter often is referred to as the FMB4 concept, architecture, model or framework.

Furthermore the invention is related to a system for implementing both the FMB concept as well as the four-layered FMB4 framework, which system consists of an integrated software/hardware infrastructure together performing the various management, coordination, data management and information management functions assigned to the Mid-Office of the FMB concept, hereafter often referred to as the Mid-Office system.

The objects and the advantages of the present invention will become apparent from the following detailed description and accompanying figures.

### DETAILED DESCRIPTION OF THE INVENTION

Description of the Figures

FIG. 1 illustrates the layout of the claim proposal in this document.

FIG. 2 illustrates the concepts of U.S. Pat. No. 6,101,479 in displaying Front Office processes, Back Office Processes and Supporting Processes in a Customer-Driven Organization as a Process.

FIG. 3 illustrates a conceptual organizational structure in agreement with the invention by introducing the Mid-Office concept between Front Offices and Back Offices.

FIG. 4 illustrates the basis embodiment of the conceptual Mid-Office by displaying its major functions.

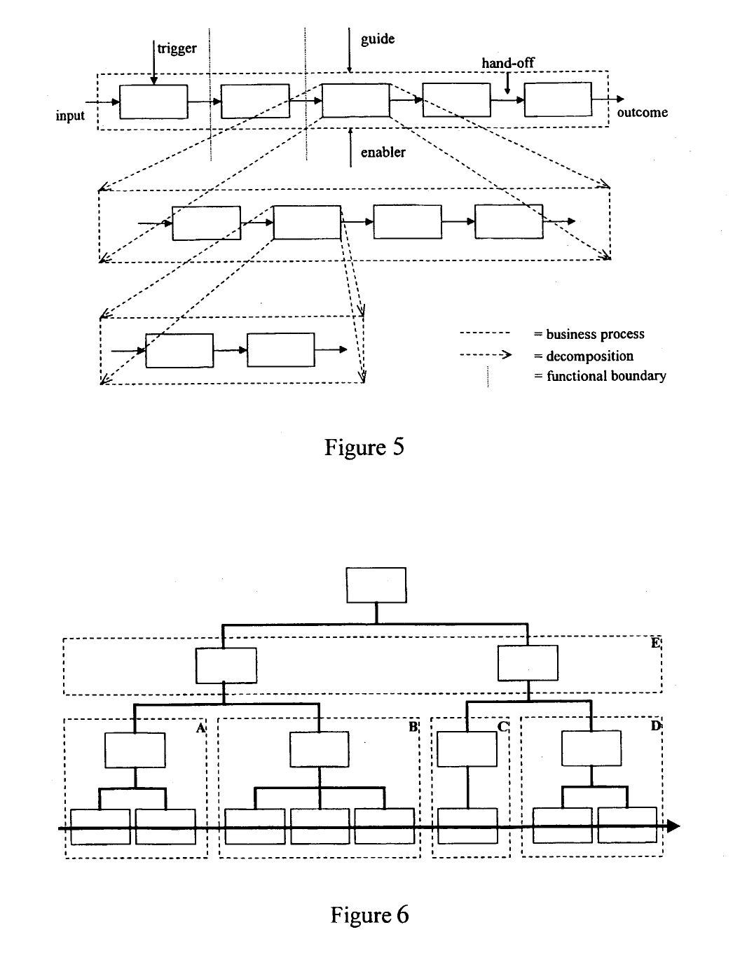

FIG. 5 illustrates the anatomy of a business process as a key concept to the invention.

FIG. 6 illustrates how an organization can be seen as a set of processes instead of the usual approach to look at an organization as a set of hierarchically management specialized functions.

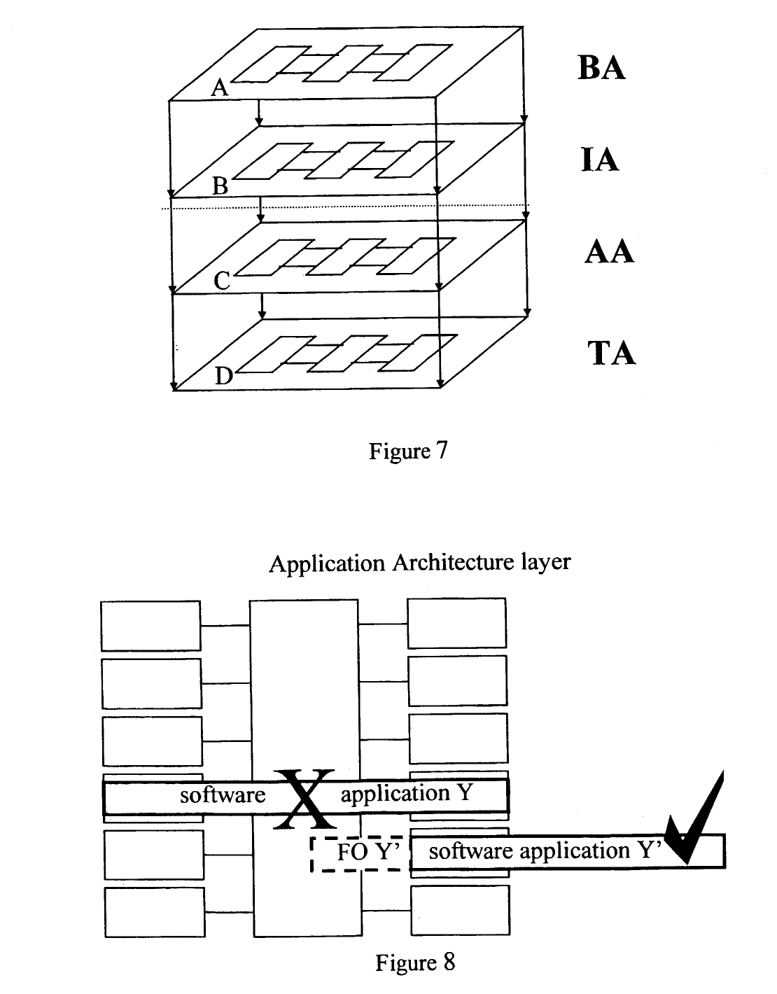

FIG. 7 illustrates the FMB4 architecture framework constructed on the basis of the Mid-Office concept in order to allow for implementation of this concept and in order to align organization architectures and objects in order to improve organization performance.

FIG. 8 illustrates an example of the practical value of applying the FMB4 framework to software applications in the Application Architecture layer.

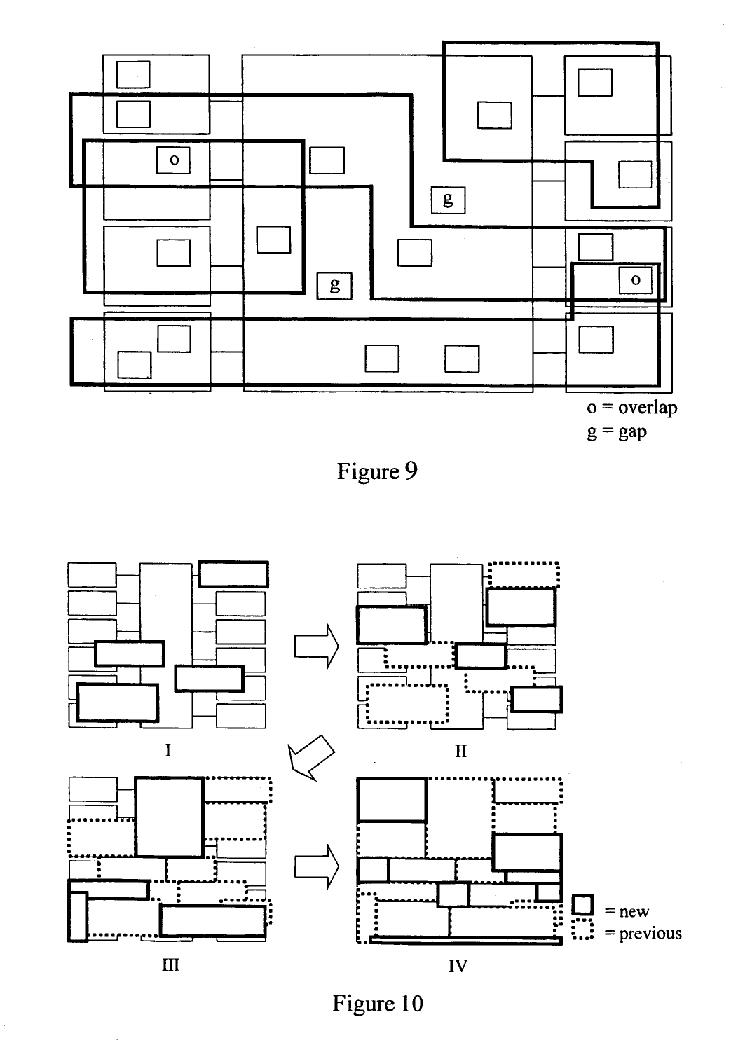

FIG. 9 illustrates project mapping capabilities as a result of applying the FMB4 framework to interdependent project portfolios.

FIG. 10 illustrates the possibility of planning organization change and improvement by applying the FMB4 framework as a migration path through time.

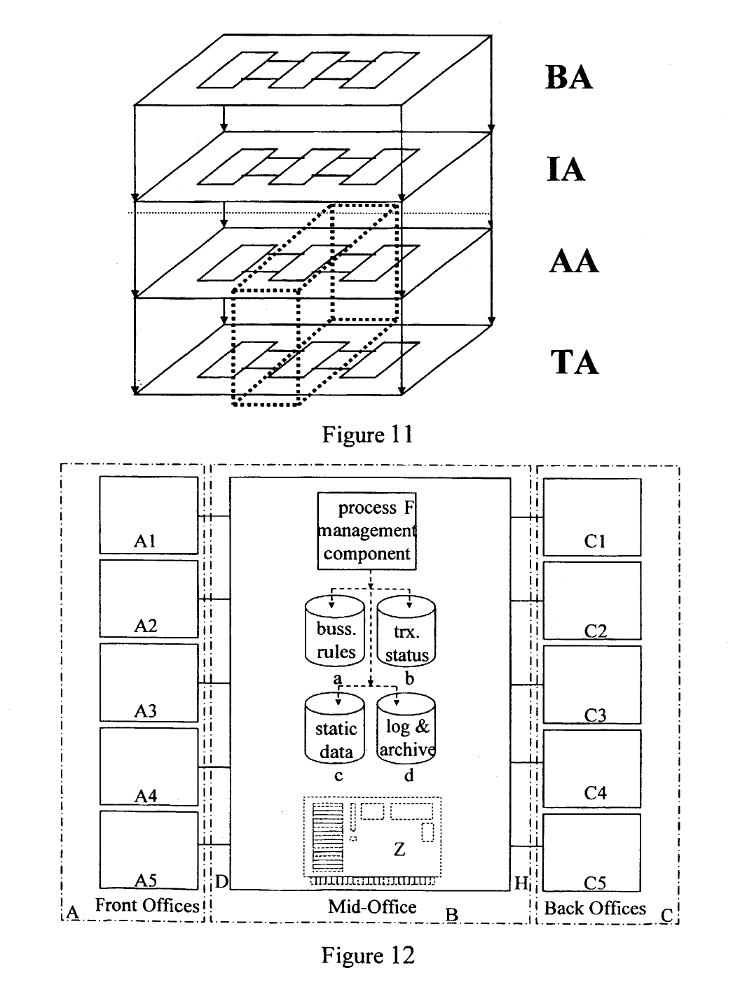

FIG. 11 illustrates the scope of the Mid-Office as a system, which incorporates the Mid-Office concept and the FMB4 framework by automating the Mid-Office Application Architecture and Technical Architecture sections of this FMB4 framework.

FIG. 12 illustrates a simplified application architecture of the Mid-Office system as a minimum set.

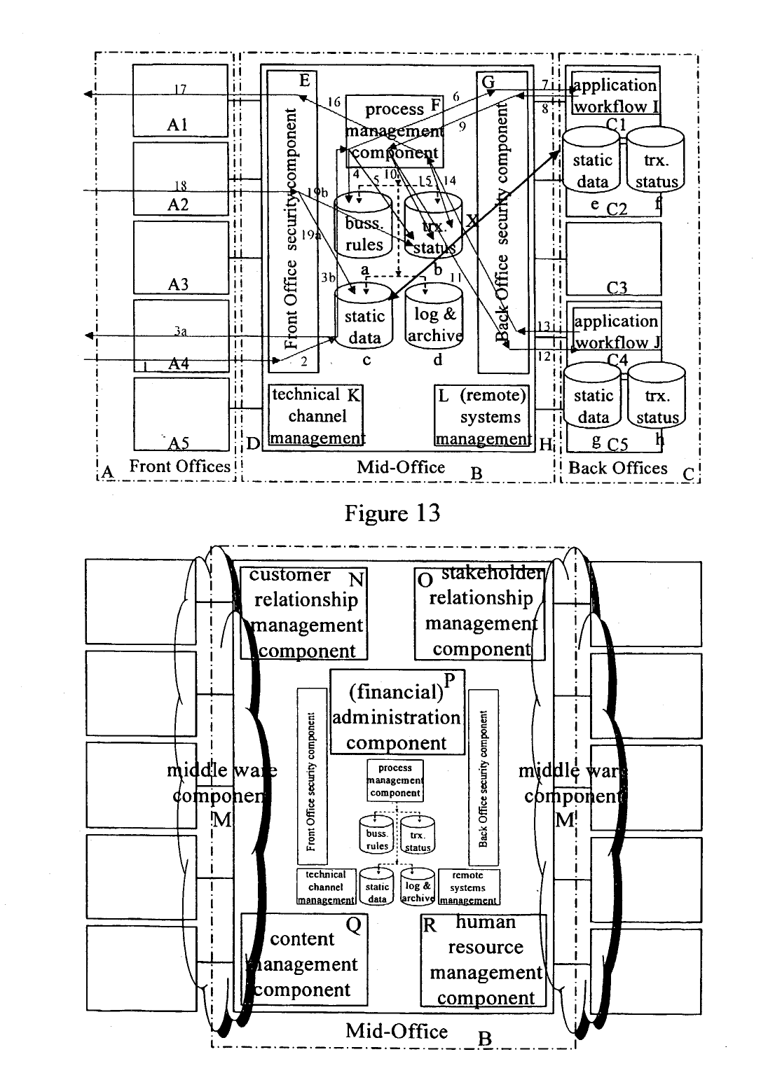

FIG. 13 illustrates a simplified application architecture of the Mid-Office system as an extended set, including an example of a flow of events.

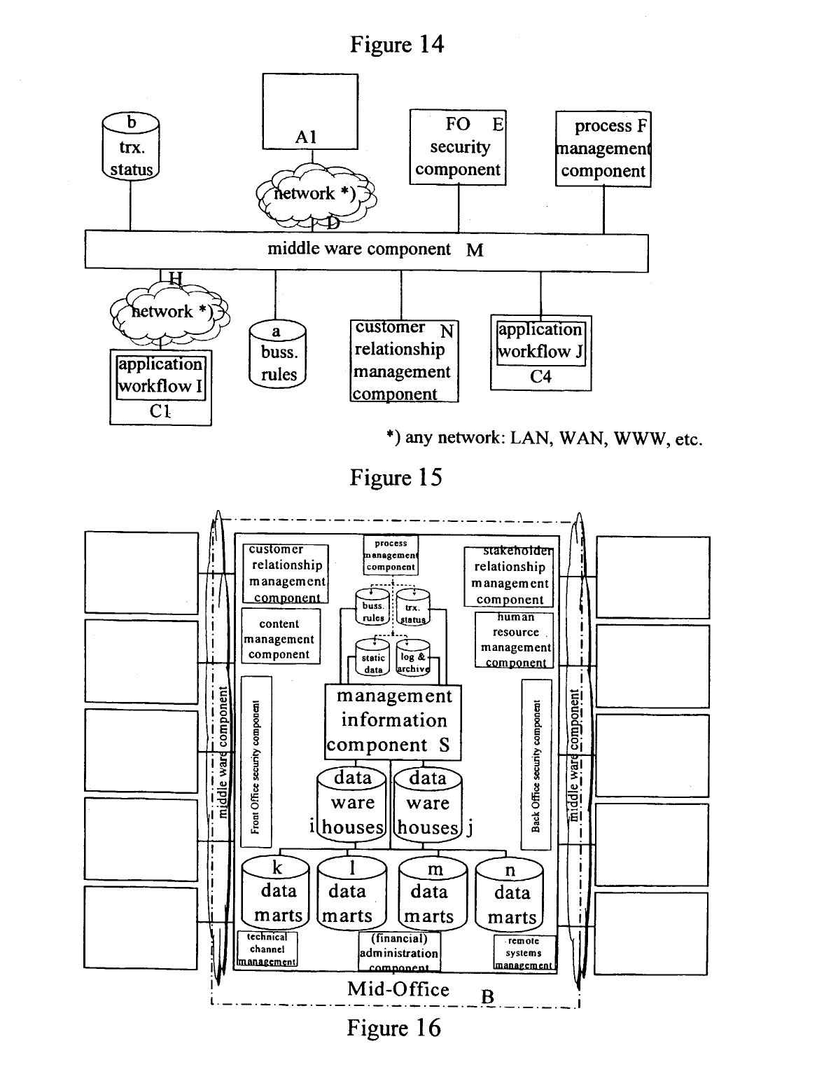

FIG. 14 illustrates a simplified application architecture of the Mid-Office system as an extended set.

FIG. 15 illustrates a simplified example of the working of middleware technology.

FIG. 16 illustrates a simplified application architecture of the Mid-Office system as an extended set.

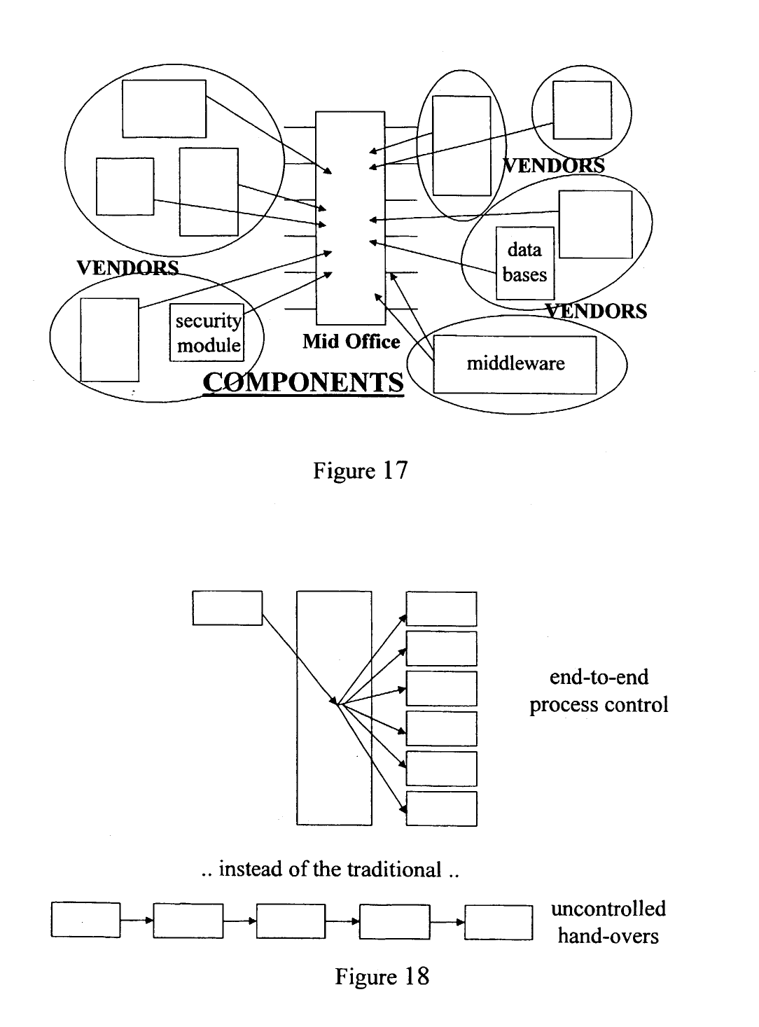

FIG. 17 illustrates how the Mid-Office will be created by integrating (near) best-of-breed components supplied by different software and hardware vendors respecting all patents of these components and the underlying inventions.

FIG. 18 illustrates how implementation of the Mid-Office system in an organization leads to end-to-end process control and therefore Total Quality Management in that organization.

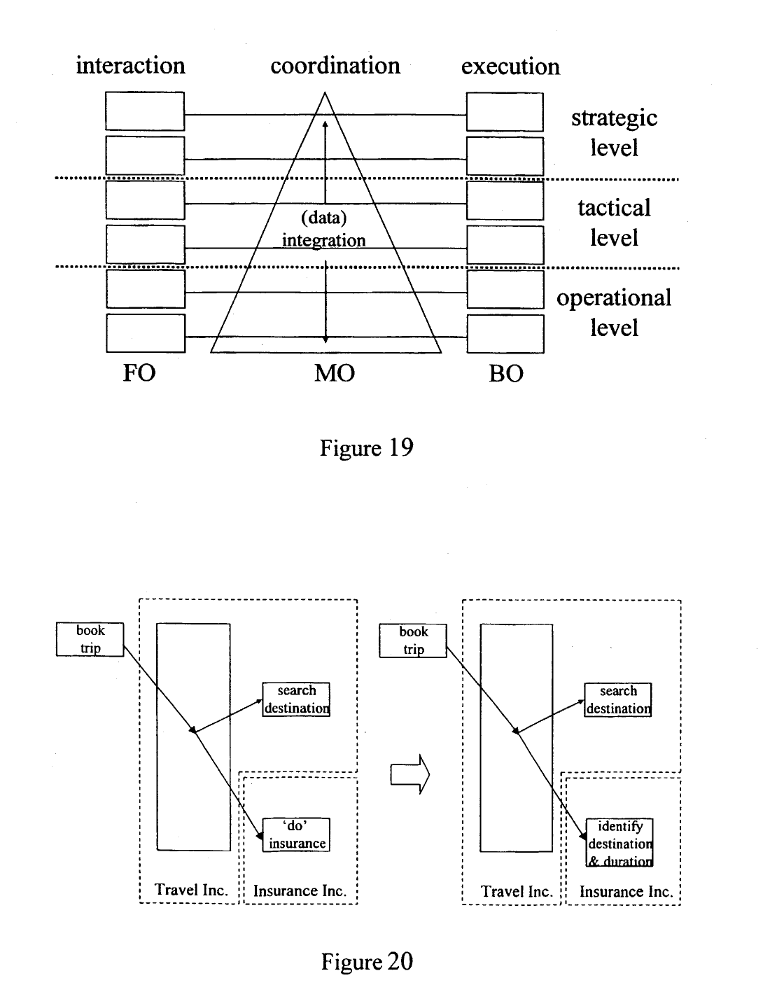

FIG. 19 illustrates how implementation of the Mid-Office system in an organization leads to increased management control at all levels in the organization: strategic, tactical and operational.

FIG. 20 illustrates how implementation of the Mid-Office system in an organization facilitates opportunities for increased effectiveness and efficiency through increased granularity of Back Offices to allow for continuous improvement.

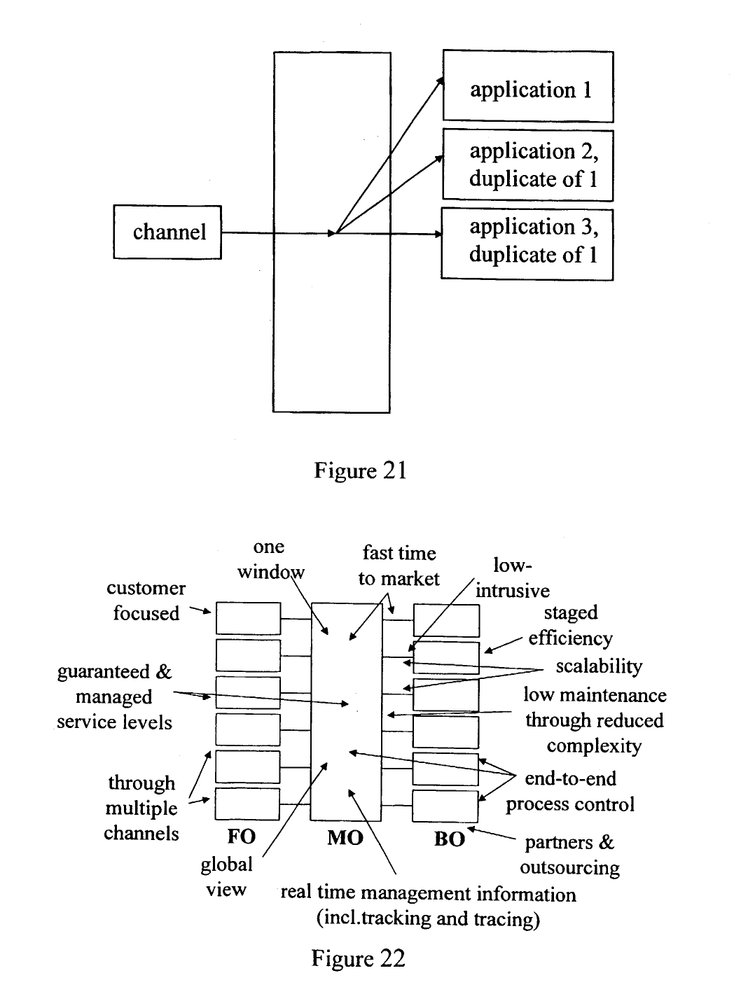

FIG. 21 illustrates how implementation of the Mid-Office system in an organization facilitates explosive growth through instant and endless scalability of the total solution.

FIG. 22 illustrates a summary of benefits of implementation of a Mid-Office system in an organization.

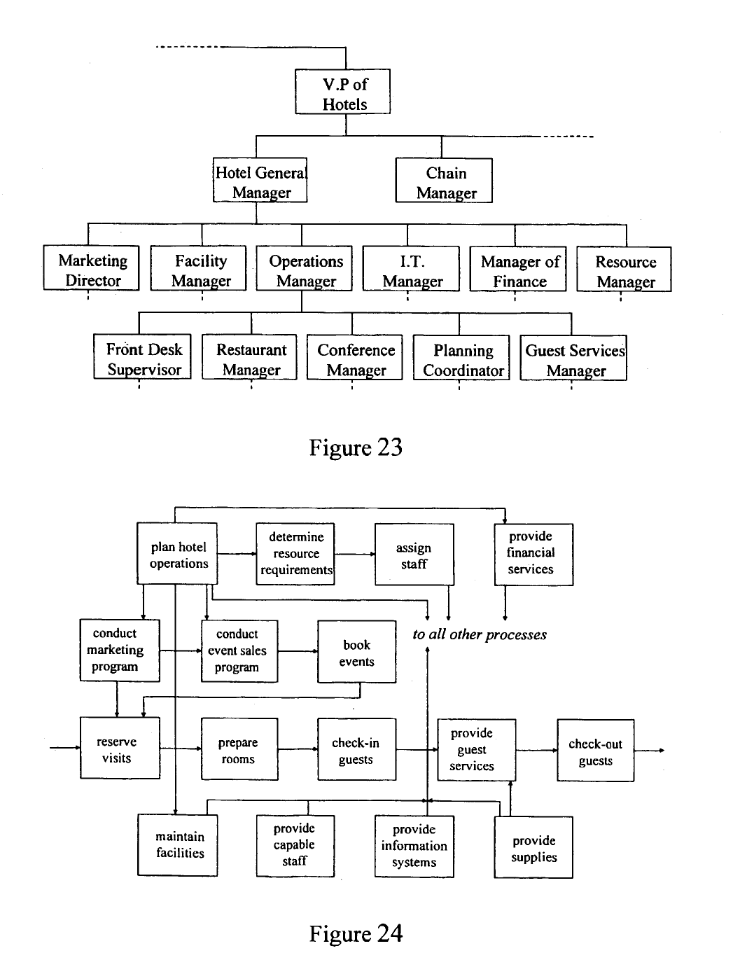

FIG. 23 illustrates an organization chart for the example of a hotel business to support the application of the FMB4 framework.

FIG. 24 illustrates a high-level process architecture for the example of a hotel business to support the application of the FMB4 framework.

FIG. 25 illustrates a rearranged high-level process architecture according to the FMB4 framework for the example of a hotel business to support the application of the FMB4 framework.

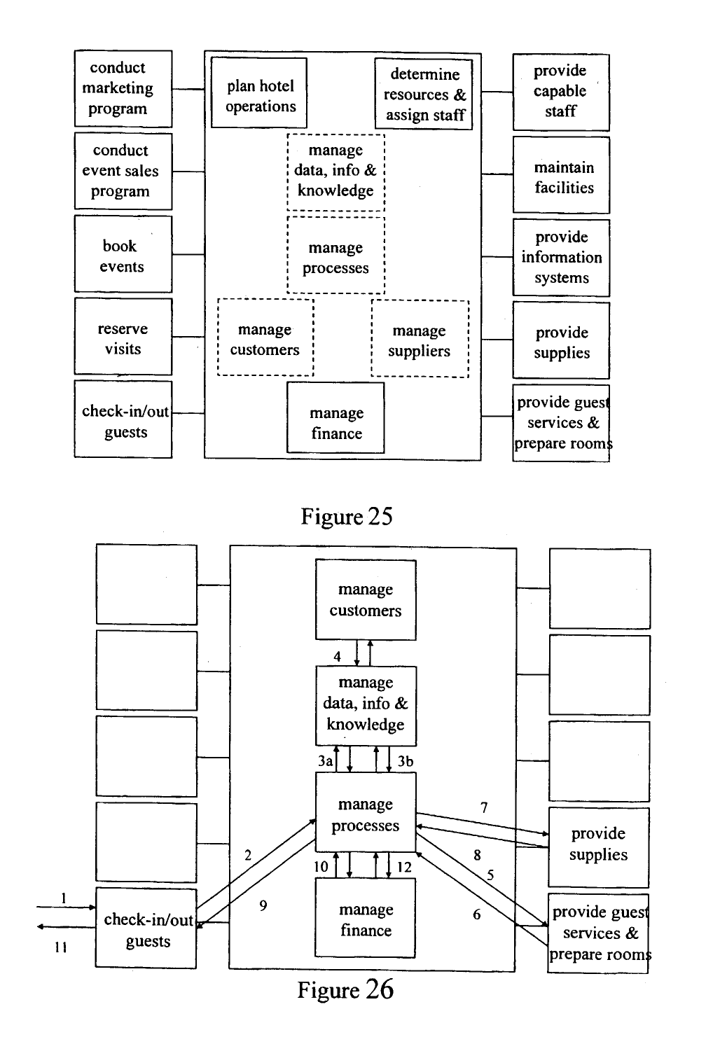

FIG. 26 illustrates some processes flowing through the high-level process architecture for the example of a hotel business to support the application of the FMB4 framework.

The Basis of the Invention: The Mid-Office Concept

The current challenge for many organizations more then ever before, is how to connect multiple Front Offices to multiple Back Offices, as described in U.S. Pat. No. 6,101,479 (FIG. 2). New delivery channels as internet, mobile phones and palm tops conquer the world, bringing convenience to its users. Traditional channels such as front desks, outlets, street branches, vendor machines, fax and regular mail are there to stay for the unforeseeable future. At the same time, Customers start to demand non-traditional services, requiring more service providers and Back Offices to be involved in the process of service provision. It will be clear that there has to be a communication network between the Back Offices and the Front Offices and vice versa enabling the Front Offices to send orders to one or more Back Offices for performing a specific service requested by a Customer and for receiving from the Back Offices the results of the performed tasks. On the other side each of the Back Offices has to be able to communicate with any of the Front Offices to receive its orders and to transfer back the results of the performed tasks. Trying to connect all these Front Offices to all these Back Offices turns rapidly into the infamous high complexity, high maintenance spaghetti-plate. Furthermore in such architecture each of the offices need a number of resources such as data bases that contain data about the clients, the products, the contracts and about the tasks to be performed. If such a structure is implemented then in practice there will be strong tendency for each office to build its own data bases independent from the databases built by the other offices. The result thereof will be that the data transported through the network and used by the various offices will certainly not have a common meaning, format, etc. In other words, there is hardly any data integrity in the whole structure.

The current invention resolves the complexity of relationships between Front Offices and Back Offices, increases flexibility and solves the data integrity challenge by the introduction of a Mid-Office, placed between Front Offices and Back Offices (FIG. 3). By letting the Front Offices and Back Offices communicate through a central Mid-Office, the number of communication relationships between the various Offices are reduced from N*M (or even more since some Back Offices are connected to others) to N+M. In the simple example of FIG. 3, with 6 Front Offices, 6 Back Offices and 7 connections in-between Back Offices, the introduction of the Mid-Office reduces the number of relationships from 6*6+7=43 to 6+6=12.

In the FMB concept, Front Offices are still defined as processes, functions, roles or tasks that only involve interaction with outside parties (including but not limited to the Customers of the organization); the performance of a Front Office should only be measured on how well it does interaction with the outside party. Examples of Front Offices are: sales, marketing, call centers, Customer support, etc. Back Offices, however, are now more specifically defined as processes, functions, roles or tasks that only involve execution of services or production of products; the performance of a Back Office should only be measured on how well it delivers products or executes services. Examples of Back Offices are: transaction execution and order fulfillment tasks, like in the financial world: transfer of funds between banks or for a shipping company, transporting goods from A to B. Supporting processes are now either identified as being real support processes, which will position them as Back Offices rendering services to the organization, or coordination and/or management processes, which will position them in the newly introduced Mid-Office. The Mid-Office now does all coordination between any Front Office and any Back Office or in between Front Offices or Back Offices, and centrally holds, maintains, manages or keeps track of the data and information about all relevant organization internal and organization external objects (Customers, products, cost, prices, transactions, procedures, laws, etc.) necessary to properly perform the organization processes, functions, roles and tasks. The performance of a Mid-Office should only be measured on how well it coordinates all processes throughout the whole mechanism of related Front Offices and Back Offices; Mid-Office performance is therefore meta-performance (performance of the performance).

The FMB concept arranges the different functions of the organization into black boxes of Front Offices, Mid-Office and Back Offices. When examining the organization, every function gets a place in either ‘Office’, but not more than one only. In this way, there can be no confusion about the nature of the function: interaction, execution or coordination/information. By doing this religiously, all functions become ‘other-Office’ independent. Most critical is that the Mid-Office as a function becomes both Front Office and Back Office independent. This gives the organization a dramatic increase in flexibility, because in this case, new Front Offices and/or Back Offices may be added without directly influencing other Front Offices or Back Offices. If a function can fall into two Offices, it is a mixed function and should be ‘opened’ and considered at the lower level of sub-functions, that then can be properly arranged to the FMB concept. This process of decomposition should continue until all functions undoubtedly found a place in one Office only. After this has been done, the concept can be tested by mapping all major processes to this model—which has now become an architecture or a blueprint—in an end-to-end way, i.e. from initiation to finalization over the complete process life-cycle.

When opening the black box of the conceptual Mid-Office, some critical functions and processes become clear, that all together manage the whole organization on a strategic, tactical and operational level (FIG. 4). Most of the management and coordination is executed by a process management function. In order for this process management function to work, it should know the full end-to-end process from the moment the Customer or any other Third Party initiates an action or a transaction (the input) through order fulfillment (even if this goes through different parties outside the organizations, which then become Third Party Back Offices to the model) and confirmation to the Customer or end-result feed-back information to any relevant Party to the action or the transaction (the output). Since process management and therefore the process in general is such a key principle in the concept, the concept of processes in organizations is described here in some more detail.

A business process can be defined as all the necessary subsequent and parallel steps and activities necessary to achieve a certain business outcome, either once or over and over again. A business process transforms something (physical materials, information and data, knowledge or commitments) from an input into an output based on a triggering event and is usually guided by rules, procedures or knowledge, and usually supported by a certain set of enablers: people, tools (including hardware and software) and/or facilities. Business processes usually cross functions, organization units or even organization boundaries. A business process can be seen at any level; each step of a process can be considered at a lower level view and therefore comprises of a number of sub-steps: business process decomposition. The anatomy of a business process is shown in FIG. 5.

Most organizations are managed in a functional way, without recognizing the end-to-end process flows anymore. This is due to the fact that we have specialized more and more in the work we do and at the same time organizations grew bigger and bigger. Specialists in organizations are doing sub-tasks in a longer process, and only see their own part. To coordinate the work of multiple specialists (sales, research & development, manufacturing, administration, etc., compare A through D in FIG. 6), in functional oriented organizations typically another level of management becomes necessary, and, after that, another level of management (E) to coordinate the coordination. In this way, organizations become sets of silo's of which the end-to-end coordination of processes, through many hierarchical layers, may only end at the top of the hierarchy. This puts operational decision making at too high of a level and in itself makes organizations slow and less agile. Because no one in current organizations usually oversees the end-to-end process, this process can be broken without anyone knowing this. This is because a process is hardly ever broken within a step or a function, where most people know what they have to do on a day-to-day basis, based on expertise and training. Hick-ups in a process normally take place at the handovers, in-between the steps, like with relay in athletics where each of the athletes separately can outperform, but if the stick is dropped at the hand (please refer to ‘Improving performance: how to manage the white space on the organization chart’ by Geary A. Rummler and Alan P. Brache, published by Josey-Bass Publishers [1995]).

Apart from the process management function mentioned before there are some other management type of functions that particularly manage stakeholder relationships (a stakeholder is anyone individual or institution that interacts with, cares about or may influence an organization), such as Customer relationship management, human resource management, strategic partnership management and supplier relationship management, or functions that particularly manage objects and occurrences, such as product management or risk management. Since the Mid-Office, if architected well, contains all the critical management functions of an organization, irrespective which products and services they produce (Back Offices) and irrespective through which channels they offer these products and services (Front Offices), these management functions by nature become generic and therefore applicable to any organization. By specifically dividing the different functions in an organization over either the Front Office, Mid-Office or Back Office, a very clear organization model starts to exist.

At this point, all is still considered at a logical conceptual level; no physical organization components (people, information technology components, facilities, etc.) were involved yet. At this point it therefore makes sense to involve the more physical components of the organization. This is done through a four-layer architecture model that is fully based on the FMB concept as described before. This architecture model or framework is a key part of the invention and is described in detail below.

The FMB4 Framework

More and more organizations find out about the necessity of creating and maintaining an enterprise architecture. An enterprise architecture is defined as a blueprint for the whole organization or the organizational unit in focus with the purpose of increased understanding of the organization and therefore the ability to effectively change and maintain the organization. In order to accentuate the importance of architecture in organizations, below list shows some major other benefits of architecture besides being a means for communication and understanding:

it balances (conflicting) requirements, principles, opportunities and constraints

it balances the short term with the long term and therefore prioritizes change

it allows the organization to gain speed of change through parallel development

it adds flexibility to the organization by independent layering of the architectures

it facilitates to appropriately scope new projects

it provides improved decision masking on projects by clearly showing the consequences of solutions

it forms a guide to projects and helps to control dependencies

it relates IT-solutions in an understandable way to business requirements

it is a vehicle for standardization, thus increasing efficiency, and—through better understanding—effectiveness

it therefore gives continuity in and consistency of decisions

it gives confidence that solutions will work by using patterns and templates of ‘proven’ technology and ‘best practices’

it streamlines business processes discovering and eliminating redundancy

it is the documentation and repository of shared knowledge

it reduces information systems complexity which leads to fewer applications and thus costs

it enables enterprise-wide integration through sharing of data and common services and reusing of components

it provides guidelines for organizational change and system development

it helps to better maintain the solution

Or in one statement: architecture allows an organization to change in a planned way. As a house is a construct, an artifact designed and created by men in order to realize a specific purpose, an organization is a construct, an artifact designed and created by men in order to realize a specific purpose. A good organization is specifically designed for realizing that purpose. A better organization is designed for realizing multiple purposes beyond the one purpose. The best organization is designed for changing itself continuously with the change of its purposes: it has flexibility incorporated in the design. This is exactly what the FMB4 architecture framework and the Mid-Office system accomplish, as this document will demonstrate.

If organizations want to benefit from implementing the FMB concept, it is necessary to create an architecture model or framework that allows for considering all relevant architecture layers in an organization whilst at the same time respecting the FMB concept for implementing its benefits. This is necessary, because some architecture layers describe better the physical requirements in order to implement said concepts. The FMB concept as described before was viewed so far from a logical, functional perspective of the organization considering processes, functions, roles and tasks, all linked to the objectives of the organization. This can be considered as a first architecture layer and is usually referred to as the Business Architecture (BA) of an organization. The Business Architecture layer according to the FMB concept structures the organization's business in a set of rather autonomous business roles, each responsible for realizing specific business functions. Since roles are organization-independent it becomes easy to change the organization by assigning the same roles to other organizational units. Also, the roles can be performed in different physical and/or geographical locations. Together the roles fulfill the end-to-end processes. By breaking up the processes and products into small roles and components it becomes possible to reorganize them and easily allow for outsourcing or changing suppliers of services. Through the autonomy of business roles a set of cooperating functions is obtained (the ‘network organization’).

In order to be able to physically implement the processes, functions, roles and tasks, some other architecture layers need to be considered (FIG. 7). A second architecture layer (B) is defined and describes the information flows and data elements that support the processes, functions, roles and tasks described in the top layer Business Architecture (A); this second layer is referred to as the Information Architecture (IA) of an organization. A third architecture layer (C) describes the software applications and systems necessary to support the processes, functions, roles and tasks of the first layer as well as the information flows and data elements of the second layer; this third layer is referred to as the Application Architecture (AA). A fourth and final layer (D) describes the hardware, operating systems and networks necessary for the software applications of the third layer to run on; this fourth layer is referred to as the Technology Architecture (TA). A multi-layer FMB concept is the result, matching each architecture layer into the same FMB pattern (FIG. 7). Because each architecture now follows the FMB concept, the different layers together can form a consistently aligned framework. This makes it easy to understand the relationships between these four architectures and see how required business functionality is to be supported by information and how it will be realized with technology. Therefore, the model bridges business with IT. By doing this, all functions, processes, roles, tasks, information, data, software applications and hardware systems become aligned over four layers of FMB pattern: the FMB4 model. The layering described here is an analogy of the principles of the well-known OSI model, which in seven layers separates the different levels of execution of communication. In order to support the practical application of FMB4 architecture concept, Appendix B shows a practical example in the form of an example of applying the FMB4 Framework to a business hotel.

By the FMB4 framework, the total integration becomes visible: how all entities are related and how they are connected to each other. It helps to create the bridge between business and IT (Information Technology), something organizations usually struggle with. On top of that, usually within IT functions of organizations more than one architecture exist, either explicit (in documentation) or implicit (in the heads of people). Often, these architectures are hard to align, since all individuals speak from their own blueprint. The FMB structure on the Application Architecture and Technology Architecture layers will give all IT officers in an organization a common reference model to start understanding each other's architectures by use of this now commonly accepted standard, like Esperanto or English would do for languages. In this way, the FMB4 model also bridges IT with IT.

An important factor of fitting software applications in the FMB4 framework is to achieve maximum organization flexibility. Usually, software applications exist of their own Front Office (the delivery channel or user interface), their own execution modules (the factual Back Offices) and their own workflow, connecting the different execution modules and databases to each other and the user interface. Since this workflow is often fixed, and proprietary to the whole application, organizations are usually stuck to this workflow throughout the whole sequence of events. In fact, they more or less have to adapt the business environment and the business processes in order to be able to work with the applications. But organizations work with multiple applications, that work with their own user interfaces, execution modules and workflow. The total of these applications make the organization reluctant to change: the software applications do not allow for great flexibility in itself and changing one application may cause other applications to stop functioning. FIG. 8 illustrates how a software application Y covers the Front Office, Mid-Office and Back Office of the FMB concept. Their is no other way to work with this application than to follow its implicit workflow from Front Office to Back Office and back, using the application specific Front Office as the only channel to interact. If we now apply the FMB architecture, and assume that the core of the application is execution, the software application is now put in its appropriate ‘box’ or ‘Office’: as as a Back Office (Y′) [of course, if the core of the application rather supports Customer interaction than service execution, the application should be positioned in the Front Office]. Now it maybe appropriate to bypass the application's proprietary channel (FO Y′), and to connect the Mid-Office immediately to the workflow that arranges the sequence of execution. In this way, the workflow has been put on a higher level, in the Mid-Office, causing higher flexibility and the software application is connected to all available channels of the organization and not only to the former proprietary user interface of the application. This flexibility may become even more prominent, if the application is modular, and each module is considered a Back Office, with its own connection to the Mid-Office. Now total workflow control is transferred to the Mid-Office for maximum flexibility and configuration.

Another important factor in the FMB4 architecture is the independent layering: though the four layers of architectures are consistently mapped to the same pattern, each layer should be de-coupled and therefore independent from the others as much as possible. This can be achieved, if each of the architecture layers are connected to the others through specific principles, standards, conventions, and requirements and within layers each of the objects or components are connected through interface definitions and/or protocols. If this principle is followed, an organization keeps the optimal flexibility to change areas in one layer, without significantly affecting other layers. One example of such layer independence principle is ‘platform independence’. This means that any software application, selected, bought or built to be integrated in the Application level architecture of the FMB4 model must be able to run on the most common hardware platforms and operating systems. By this principle, a component in the fourth (Technical layer) can be replaced without causing any significant change in the third (Application) layer (apart from set-up and testing of the affected software applications, of course). The other way around, the principle of platform independence allows for easy selecting alternative software applications for substitution; this is an important option, since a software company that delivers best-of-breed solutions now, may not be around next year, so this flexibility in substituting applications gives in fact a flexible and therefore reliable and stable business environment. This is also why it is important to separate the business processes from the supporting IT applications. Many organizations currently still adapt the workflow of the business process to match it with the workflow of the application that supports that process in order to keep the application untouched and therefore stable and reliable. This means, that if the software application is replaced or altered, the process must be changed and, in some cases, the whole department reorganized . . . just for a software matter. Once the organization manages to keep to the principle of independent layering, full use can be made of the concept of reusability of (software) components. Since the application is detached from the workflow of any process, it can be introduced at any place at any process where there is a requirement for such functionality. This fits in the ‘Service Oriented’ nature of the architecture, and allows for new development methods such as ‘Component Based Development’. In a Service Oriented environment applications merely consist of an invocation of a series of services which together perform an end-to-end business process. These services can be categorized as product related services, common services, delivery channel services and external services. Categorizing services prevents the frequent intermixing of functionality that is characteristic of legacy applications. Also, different types of services have their own dynamics and may evolve independently. Product related services perform functions, which are specific to a single product. Common services perform functions, which are shareable by several products. External services are performed outside the scope of the organization (in focus); for the organization they exist as interfaces to or from the outside world. The development method of Component Based Development supports this notion, since small modules of applications are specifically developed for being reusable in a total implementation with other reusable components that can be called upon by a workflow engine or a process manager.

The FMB4 architecture is also a great tool for managing the interdependencies between projects for organization improvement or systems development, because in one consistent blueprint it shows how projects overlap—with the risk of doing double work at double costs—or how projects leave gaps—causing flaws, bottle-necks or opportunity cost. It can show the shared objects and components of projects, that would enable the organization to rationalize solutions and not invent and create the same wheel in many different projects. FIG. 9 shows an example of such project mapping, on any of the four layers: some projects have an overlap (function or activity ‘o’), some functions or activities fall between projects, and could mean a gap (‘g’). Bigger organizations are notoriously known for their implementation of for instance many Customer information files, a contract databases and security applications since they develop them per solutions, and therefore almost per project. The set of aligned architectures allows organizations to identify those common services. Placed in the Service Oriented architecture of the FMB4 model, these common services only need to be developed and implemented once, not with every new project or solution, allowing for increased efficiency and data integrity.

When the architecture is aligned to the (strategic) objectives of an organization, the architecture also helps define the migration path (FIG. 10) by creating multiple architectures with different consecutive time horizons from the AS-IS to the TO-BE, thus adding a next dimension: time. Each architecture can solve the issues at the appropriate time frame, without substantially deviating from the general direction of the envisioned future state. Though there will probably always be a conflict on what is necessary on the short term vs. what is necessary on the longer term, architecture and architecture principles help to solve these challenges and to demonstrate impact of chosen solutions.

From a technological viewpoint, recent possibilities within information and communication technology (ICT) offer just the kind of functionality that is necessary making implementation for a FMB concept feasible. Technology for Front Offices in order to optimize interaction with the Customer includes call center technology (computer/telephone integration), browser technology, the Internet, mobile phones (including wireless application protocols WAP), etc. Back-office technology in order to optimize efficiency, speed and large scale transaction processing especially include remote systems management software, intelligent agents, enterprise application servers and mainframe/server capacity. Examples of Mid-Office technology in order to optimize flexibility, integration, communication and coordination are process management and intelligent workflow software, distributed database technology, data warehouse/data mining/data synchronization software, business intelligence and business rule technology, CRM (Customer relationship management) and supply chain management applications, Component Based Development and intelligent software agents. Interfaces between Front Office, Mid-Office and Back Office can be done through the modern concepts of middleware technology, further reducing the complexity of still maintaining a number of interfaces. Based on the technological feasibility of the concept and the framework, the next step of the invention therefore is the creation of a physical Mid-Office system: a generic organization independent integrated software and hardware infrastructure that integrates all automatic functions that the Mid-Office in concept needs in order to dramatically improve and thoroughly manage an organization. Below, this Mid-Office system is explained in more detail.

The Mid-Office System

The system that will be developed based on the FMB concept and the FMB4 architecture framework constitutes a flexible and scalable integrated software and hardware infrastructure and as such covers the Mid-Office part of the third and fourth architecture layers (Application Architecture and Technology Architecture) of the FMB4 framework (dotted line in FIG. 11): it is the embodiment and operationalization of the Mid-Office concept and therefore supports all management and coordination functions in an organization by connecting all Front Offices to all Back Offices through one logical single point of interaction. Though the Mid-Office is a central component, that enforces centralization, it does not need to work in a physically concentrated environment. Every single role and every single function in the FMB concept can be performed by whatever organizational or physical unit at whatever geographic location. Centralization of functions and services therefore does not necessarily equal physical concentration of these functions and services; they therefore can function in a distributed environment. The total set of distributed unique services at anyone time equals the logical centralized model. Only some critical, almost ‘atomic’ functions should be unique, such as security and lock management (for application and/or database locking). As a centralized model, the introduction of the Mid-Office immediately brings standardization in a normally non-standardized environment.

FIG. 12 illustrates the simplified application architecture of the Mid-Office system (minimum set). The total mechanism exists of an arbitrary number of Front Offices A1 through A5, with the total set of Front Offices indicated as A, one Mid-Office B and an arbitrary number of Back Offices C1 through C5, with the total set of Back Offices indicated as C. All Front Offices A are connected to the Mid-Office B on a logical one-to-one basis by means of direct links or networks D (Local Area Networks or LAN's, or Wide Area Networks or WAN's, the World Wide Web or WWW, or any other network supporting all protocols); even so, all Back Offices C are connected to the Mid-Office B on a logical one-to-one basis by means of direct links or networks H (Local Area Networks or LAN's, or Wide Area Networks or WAN's, the World Wide Web or WWW, or any other network supporting all protocols) The Mid-Office as a minimum set consists of a process management software component F, as well as a business rules base or RuleBase a, a transaction status database or administration b, a static data database c and a log file and archive database d, optionally running on a single or multiple hardware platforms Z (including the appropriate operating systems). Hardware platform is the generic term for any computer, comprising technical components including but not limited to processors, registers, memory places (Read Only or Random Access), input/output facilities (such as keyboard, computer mouse, touch screen, graphical displays, monitors, printing devices, reading devices for reading tapes, disks, etc.); types of computers could be personal computers, midi computers, mainframes and servers. Further explanation is considered superfluous since detailed content is known by experts in the field. In this minimum scenario, the Mid-Office has become an intelligent middleware component (the explanation of middleware is due later this section), with the purpose only to coordinate the end-to-end processes over the now separated Front Offices and Back Offices. The hardware Z is optional, since the system can be developed as software only and loaded on the hardware platform of any Customer organization (which platform then becomes logically part of the Mid-Office).

FIG. 13 builds on FIG. 12 (assuming the optional hardware to be there in some form or the other) while adding a Front Office security software component E, a Back Office security component G, a technical channel management software component K and a (remote) systems management software component L. The security software component is added to carry out security tasks which are Front Office and Back Office independent, supporting the generic character of the Mid-Office, such as to authentication, authorization, transaction security and encryption/decryption, with the purpose of allowing only authorized parties to do authorized actions as well as to manage integrity of all data, including safeguarding privacy and the proprietary nature of data and information, both in the direction of Front Offices and Back Offices. It is at this point where the conceptual management functions of the Mid-Office get supplemented by more technical management functions, such as a technical channel management software component K and a (remote) systems management software component L. The system management component is added to carry out system management tasks, such as exception handling, recovery and error recovery, time management, check pointing, load balancing, logging and restart capabilities for the whole mechanism, including Front Offices, Mid-Office and Back Offices. The technical channel management component is added to carry out technical channel management tasks in order to monitor, manage and report on channel behavior for the whole mechanism, i.e. all channels that connect all Front Offices, Mid-Office and Back Offices, including shifting channels in case one channel is down [this applies especially where the logical one-to-one connection in reality is achieved by more than one technical/physical connection]. Back Offices (C) may consist of their own software applications such as application I in Back Office C1 and application J in Back Office C4. Both applications I and J have their internal application workflow and may have their own proprietary respective databases connected, such as static data database e and transaction status database f for application I and static data base g and transaction status database h for application J.

A flow of events is drawn in this FIG. 13 which starts with an outside party, for example a Customer, triggering the events by sending (1) a transaction for execution to the mechanism by using Front Office A4 (for example a phone call to a call center). The transaction is intercepted at the Front Office security software component (E), where the transaction is decrypted if necessary, and where the authentication of the Customer is established through different security options (token, user id, password, etc.) as well as the authorization of the Customer for the specific transaction by checking (2) the Customer authentication and authorization security data in the static data database (c). If the security check fails, the transaction is rejected and the Customer informed (3a) through any Front Office, but most likely the one the Customer used in the first place (A4). If the security check passes the transaction is made known (3b) to the process management software component (F) which based on the information of the static data database (c) now recognizes the Customer and the transaction. Based on this information, the process management software component (F) accesses (4) the business rules in RuleBase (a) in order to determine the end-to-end process that this particular transaction should follow for this particular Customer. This is possible since the relevant process has been documented and has been translated in a set of business rules that are previously loaded into the RuleBase (a). Once the process management software component (F) determines which first task needs to be executed for this transaction, it sends (7) this transaction to the appropriate Back Office C1 for processing this first task, passing through (6) a Back Office security software component (G) necessary to add the appropriate encryption, authentication and authorization information in order for the Back Office C1 to determine if this transaction is appropriately originated. This could be specifically the case if the Back Office C1 is not an organization internal but a third party Back Office. The Back Office (C1) in this example exists of a single software application component (I), with its own internal workflow. At this point, the process management software component (F) updates (5) the transaction status database (b), in order to keep track where the transaction is and at what time it is sent there. Based on the service levels of the Back Offices (C), known by the process management software component (F) by means of the product and process data as a part of the static data database (c), it can now monitor the service level of Back Office C1 (it does not worry about the application workflow inside the software application inside Back Office C1, since it considers Back Office C1 as a black box with a known input and a desired output within a desired time frame only). The application (I) in Back Office C1 now executes the first task of the transaction, preferably by using the static database (c) in order to keep consistency and integrity in static data, but most likely by using its own proprietary static database (e), as well as a proprietary transaction status database (f) in order to support the workflow in the application (1). In order to still keep consistency and integrity in static data throughout the whole mechanism, the static database (c) of the Mid-Office and the static database (e) of the application (I) in Back Office C1 are continuously synchronized (X), with the static database (c) of the Mid-Office (B) being the principle one: the ‘Truth’ in the whole mechanism. Also for the sake of transaction status information, the transaction status database (b) of the Mid-Office (B) is the principle one and is also considered as the ‘Truth’ in the whole mechanism. The content of any static database and/or transaction database other than the static database (c) and transaction status database (b) residing in the Mid-Office (B) are therefore considered of secondary importance for the whole mechanism. When the application (1) in Back Office C1 is finished processing, it sends (9) feedback information back through (8) the Back Office security software component (G) to the process management software component (F). [If the process management software component (F) does not get feed-back within the known service level agreement for Back Office C1, or if it receives feedback that indicates the fail of the execution for this transaction, it triggers an exception handling process, that could involve a special Back Office C and potentially a message back to the Customer through a special Front Office A in order to warn for delays in transaction execution]. If the process management software component (F) receives feedback that the first task has been successfully executed, it sends (12) the transaction to the next task to be executed, in this case to Back Office C4 for processing this second task, passing through (11) the Back Office security software component (G), while at the same time updating (10) the transaction status database (b). By doing this consistently all the time, by means of the transaction status database (b), the process management software component (F) may know all statuses of all transactions at any one moment in time. Consequently, at any given moment total balances can be drawn of any transaction status stored in the transaction status database (b). [This supports the concept of the build-up of dynamic data information based on the calculation of totals of the detailed transaction status data. At anyone point in time, the balance of the process or the organization can be drawn by adding new transaction to previously calculated and stored balances, or by building up balances from scratch]. The transaction is now in Back Office C4, which also exists in this example of a single software application component (J), with its own internal workflow. Through this workflow the application in Back Office C4 executes the second task (again possibly using its own static data database g and its own transaction status database h, but preferably using Mid-Office static data database c), which for the sake of this example also is assumed to be the last task for this transaction, realizing that transactions in general may require many tasks to be executed by applications running in many different Back Offices C. When the application (J) in Back Office C4 is finished processing it sends (14) feed-back information back to the process management software component (F) through (13) the Back Office security software component (G). The process management software component (F) updates (15) the transaction status database (b) and sends (17) a confirmation of execution to the Customer passing through (16) the security software component (E) through Front Office A1 (for example, an SMS-message on a mobile phone). At all times, the Customer can enter (18) the mechanism (for example through an internet web site in Front Office A2 (but always passing through the Front Offices security software component (E)) to verify (19a) its personal static data in the static data database (c) or to determine (19b) the transaction status of a transaction initiated by this Customer by inquiring the transaction status database (b). Finally, the transaction information is stored in the log and archive database 2, for later reference, evidence, analysis or reporting.

FIG. 14 illustrates the simplified application architecture of the Mid-Office system of FIG. 13, while adding a middleware component M, a Customer relationship management software component N, a stakeholder relationship management software component Q, a (financial) administration component P, a content management component Q and a human resources management component R. The middleware component will be explained in the next paragraph and by FIG. 15. Customer relationship management software supports storing Customer behavior, status and profile data. This will help to support mass-customization, by customizing transactions to the individual Customer profile information. Based on this information, more, other or more specific services may be marketed. Stakeholder relationship management software components support management of other stakeholders than the Customer, for example managing suppliers. Storing behavior, status and profile data of suppliers will help to support Electronic Commerce (or E-Commerce) by electronically accepting offers, ordering goods or services, accepting bills of loading, accepting and settling invoices and filing complaints. The (financial) administration software component keeps track of the assets and liabilities and the profits and losses of the organization unit, the organization or the group of organizations in focus. It is a (financial) translation of the status of the whole mechanism in terms of keeping records and books according to desired or official accounting rules.

In the previous it was assumed that all components of the whole mechanism, including all Front Offices, Back Offices and the components within the Mid-Office are functioning with completely compatible software and hardware. In general most organizations will have software and hardware of different suppliers running under different operating systems which are not always compatible and running on hardware platforms which each may have their own requirements. To provide a solution therefore a standard translation between hardware and software protocols, interfaces, media formats and requirements become necessary. This is achieved through specific software called middleware, generally developed and marketed for easy integration of applications and systems. This middleware now will provide an adaptation between the software/hardware requirements of the Front Offices with the Mid-Office, an adaptation between the hardware/software requirements of the various Back Offices and Mid-Office, as well as an adaptation between the various components within the Mid-Office. By the use of middleware it becomes relatively easy to connect the Mid-Office to various Front Offices or Back Offices of a different nature, with different connectivity, different hardware platforms, different operating systems, etc. FIG. 15 illustrates the concept of middleware. Middleware forms a central information bus, which connects all software applications and hardware infrastructure. Different software applications, seen as services, can call each other or provide each other information by sending messages using this middleware layer. The middleware works application independent and translates all message formats into standard message formats for further delivery. Services become ID's or addresses which the middleware can use to deliver messages: the address feature of middleware. Middleware also provides security features as well as translation features (translating media and formats from one application to another). The middleware layer is connected to applications in two basic ways: either by respecting the interface protocol of the application and open the application to connect to the riddleware, or by means of adapters: these are links that wrap the application, ensuring that their is hardly any coding needed in the software application to apply it to the middleware concept. Although wrapping maybe second best (it means an extra component, with two extra interfaces between the application and the middleware, with potential delays and error increasing chances), it means a very elegant solution as a relative low intrusiveness factor: ease of implementation in an existing environment without disrupting that environment. Certain adapters may be used for different applications; some applications may require a new adapter to be developed and implemented. Based on this, the Mid-Office—connected itself through middleware technology—can easily be connected to Front Offices and Back Offices in the organization where it is implemented. This can be achieved through direct connections, but also through network connections. By the concept of introducing the middleware, the Mid-Office system supports multiple standards while almost becoming a standard itself. Where at the logical FMB concept it was mentioned that there will be one connection between a Front Office and the Mid-Office and one connection between a Back Office and the Mid-Office, on a technical level this could be more connections as in networks and nodes, managed as one. This is necessary for different reasons, including continuous connection by using alternative connections in case one connection fails.

FIG. 16 illustrates the simplified application architecture of the Mid-Office system of FIG. 14, while adding components for management information, such as a management information software component S, data warehouses i and j, and data marts k, l, m and n. The data warehouses i and j contain data that are captured from databases throughout Front Offices, Mid-Office and Back Offices, for further reporting, calculation, exploration and research. Data marts k, l, m and n are used to arrange and store data from the data warehouses i and j for supporting specific purposes. For example, if a user may want to see an up to date picture of some transaction for some payments, it maybe faster and more efficient to store that specific data in a specific data mart, instead of searching through the whole mechanism every time this information is needed. Since not only transaction management functions, but also stakeholder relationship management processes are included in the Mid-Office, the Mid-Office contains the real-time management and decision support information at any level and any process step or function in the organization.

The Creation of the Mid-Office System

The Mid-Office system will be developed based on the design as mentioned throughout this section. As mentioned before, the components that will be a part of the Mid-Office system exist today, in different levels of maturity and innovation. Therefore, building the Mid-Office will more be a matter of system integration than system development and coding. The different components necessary for building the Mid-Office will be bought, licensed or acquired in any other way, respecting all patents that are pending on all individual components and the ideas, concepts and inventions behind those. This will be done by approaching various vendors for acquiring their software or hardware components (FIG. 17); sometimes, the software components will be the core business of the specific vendor, some other times it will be a module or a by-product as part of a bigger product of a specific vendor. The advantage for each vendor will lie in reaching another market segment with a product or a by-product that was developed and built for a specific purpose: the vendor organization can now earn back product research money once spent for a specific purpose in a specific industry by the marketing of this product as a part of the organization independent Mid-Office system.

With the creation of the system, also the Development Environment will be set up, which allows for further development of the system, versioning, transition of versions and coexistence between versions.

The Mid-Office system is generic and can be in implemented in any organization to reduce complexity and increase flexibility in a multi-channel/multi-agent environment. All of the Mid-Office functions that were mentioned before under the description of the Mid-Office concept will find their way as supporting software applications and components in the Mid-Office system. Development will be done by integrating (near) best-of-breed technical components, that are already available in the ICT market. Once the Mid-Office system is developed and implemented in an organization, it contains certain system features and advantages, that will be described below.

Mid-Office System Features

End-to-end Process Management

Usually in organizations where no proper process management role is in place, the Customer is the first one to notice delays, defaults and problems. This is due to the fact that in a process one function thinks the transaction is done the moment it leaves the function, where any other function down-stream is not aware of the transaction yet. Should something happen with the transaction underway (which usually does not happen within a function, but mostly in between functions, at the point of hand-over), then no-one reacts until the Customer starts complaining about non-performance. This could be the case if the end-result should be a payment to a supplier, which will call the Customer if he does not get his invoice paid. If the process is managed in an end-to-end way by a function that oversees the whole process and is in the position to manage the in-between results and the routing, then this process manager and therefore the organization is the first one to see hick-ups in a particular process, and can re-adjust in time or inform the Customer proactively. In this way, an organization becomes more effective (meeting performance targets) and reliable at the same time (FIG. 18).

All Levels of Management

The same way as it works on the operational level (transaction initiation/order fulfillment cycles including the operational service level management of the Back Office) the Mid-Office also works on a tactical or strategic level, as long as the business process is the focus. An example of a tactical level of Back Office management would be capacity management. For that, the information in the sales pipeline is continuously managed. That status information, combined with the related prospective Customer setup requirements information combined with the chances of materialization of the deal on any given moment provides the information of the necessary capacity in the respective Back Offices later. The other way around the Back Office capacity, if temporarily constraint by whatever reason, could be a trigger for slowing down sales activity, to avoid disappointment with a new Customer that finds out that he cannot be served right away once he signed the contracts. In most organizations nowadays, even the organization itself finds out only at that moment of truth that they cannot deliver what they promised. The strategic level of Back Office management is creating the strategic partnerships based on environment and market information as an input (the Business Context), and agreeing the (nature of the) partnership, including the services to be executed and the service levels to be managed. Ergo, the Mid-Office covers the whole management spectrum from Strategic to Operational (FIG. 19).

Fast Time-to-Market

By running every process as a set of business rules, any new transaction flow can be configured by adding or changing business rules and each (new) process can be parameterized without coding software and therefore at low effort and low cost. This will allow an organization to mass-customize its services at low cost and to achieve a short time-to-market for new products as a new Back Office is introduced. Usually, introduction of a new Back Office (system, application, service or partner) causes difficulties in system integration with other existing systems and the consistent connection through multiple delivery channels (Front Offices). With the introduction of the Mid-Office and its process management function, a new Back Office only needs to be connected once to the Mid-Office, which should be made aware of the function, the input and output requirements and formats and the service levels of that new Back Office. Now, a new process can be created, by including the new Back Office as a new set of business rules. Likewise, a current process can be altered by adding the function of the new Back Office in the existing set of business rules, at the appropriate place. At the same way, any new Front Office (or delivery channel) can be connected to the Mid-Office on a one-to-one basis. This gives the organization a high level of sustainability since also delivery channels in the future that we do not yet know now can easily be connected, without requiring the architecture to change. The Mid-Office will manage the pre-agreed service levels with the Front Offices and Back Offices and will take proper action if and when service levels are exceeded. Since the Mid-Office knows and manages the whole process end-to-end, the organization becomes far more effective in achieving its goals, which can be measured by performance targets or Customer service level agreements. Because a new Back Office is introduced real quickly, the organization has a fast time-to-market for new products. The new Back Office will be considered by the Mid-Office as a new black box, which inside processes it does not know yet. At this point, the Mid-Office should only know the behavior of the black box in terms of input/output and performance criteria. It should know what the Back Office produces, in which standard quality and speed, and where its product or service fits in an existing process (if not a newly process). Finally, it should know what exact data the Back Office needs, and in what format, and what the end result is, and in what format. It can then document the service levels, which can be managed later, add the Back Office process step as a business rule in the RuleBase and link the Back Office by means of middleware. The nature of the Back Office does not matter. It could for instance be an internal Back Office (part of the organization) or an external Back Office (that of a supplier, partner, value chain, etc.). This means, that when an organization has the Mid-Office system in place, it could start managing the value chain, which is a big advantage in a world growing towards e-commerce where organization borders fade away and the value chain becomes more important than the individual organization on its own.

No Lock in of Vendors and Applications

Since the system allows components to be replaced fairly easily, the organization can continuously improve its quality by running on (near) ‘best-of-breed’ software. In the current business context, the quality of IT companies fluctuates heavily. Who is a star now, can be a dog in just a matter of months. Therefore, the Mid-Office system provides implicit flexibility for having the appropriate quality levels available in a ‘plug-and-work’ environment. Of course, this means again that the data input/output formats and content must be known, including the required or the actual service levels. Since there is no lock-in in technology, vendor, or software, the organization with a Mid-Office system will be flexible enough to follow these developments and go for the best (or at least, substitute the worst).

Partnerships, Outsourcing, Mergers and Acquisitions

The Back Office could be as small as a software module (e.g. a spreadsheet macro) or as large as a complete organization [Back Offices do not necessarily be automated]. Both offer a product and/or service of a certain quality within required parameters. This means, that an organization can easily out-source a part of their Back Offices (another critical aspect of the New Economy, where services become more specialized and the supporting processes of one organization become the core processes of another). It also means that an organization with a Mid-Office system can easily integrate newly acquired organizations into their product offering. And one could even assume that, in a merger of equals, the Mid-Office organization can become the more dominant partner, since it has all the controls, checks and balances in place for complete manageability and the infrastructure in place for the necessary integration.

Increasing Effectiveness and Efficiency by Increasing Granularity

Because of the ‘systems view’ or ‘black box view’ of the concept, the Mid-Office system can work and show its benefits right away, without too much focusing on the inside of the black box, added as a Front Office or as a Back Office. This means that most of the benefits could be there right away. Then, after successfully integrating the Back Office in the Mid-Office concept, the black box can be opened, to determine what processes take place inside. If the required service is in a certain process step in the organization, then that process step can now become the Back Office, probably with much greater efficiency (other parts of the bigger black box may become obsolete and can be disconnected) and much greater speed by bypassing the original workflow within the Back Office and now directly connecting the specific process step in the relevant process, managed by the Mid-Office. As this can be achieved in a continuous way, both by opening black boxes to determine the content, and by doing that for every Back Office in a prioritized way, the organization is continuously improving itself in terms of quality, speed and efficiency. An example is shown in FIG. 20, where the organization is a travel agency and a Customer requires to book a trip. The process of booking a trip is assumed to be an existing one and already an efficient one, but just recently the travel agency added a service by offering a travel insurance on top of the reservation of the trip. For that purpose, they partner with an insurance company. At first, the insurance company's systems are linked to the Mid-Office at the lowest level of granularity (or the biggest ‘grain’ or ‘chunk’): the organization as a total is seen as a black box. Once that has been established, the service is up a running, although still slow and cumbersome, since the total workflow of the insurance company determines the service level. In that workflow once called upon, first the insurance company has to find out that a travel insurance is required. Then they need to route the insurance request to that specific department, which then need to find out what type of travel insurance (business or leisure) is required before they can start processing some basic Customer and travel profile data. In a next step of higher granularity (or smaller ‘chunks’) the black box at the insurance company level is opened, to see the processes underneath. Now, the Mid-Office link to the insurance company can be made at the ‘close leisure travel insurance’ process of the insurance company and therefore to the relevant systems. Now, the step gets shorter, the rest of the insurance company and its workflow is bypassed and the transaction becomes faster and cheaper. The first step in the insurance process now is not: determine insurance type, it becomes: identify destination and duration (FIG. 20).

Real Time Management Information

Most organizations have trouble measuring. Measuring operational performance, measuring financial performance as well as the reliability and traceability of the measures. Many organizations don't even have formal targets in place and fail to have an understanding of the quantifying data. Typically, a lot of organizations cannot issue formal Service Level Agreements (SLA's) to their Customers by lack of internal SLA's. It is common knowledge that one cannot manage a system (organization) if there are no measures in place and if there is no status information available. Management information (MI) exists on any level in the organization: be it the operational information about speed of transaction fulfillment, be it pipeline information of the sales process (suspect, prospect, Customer), be it financial information (cost price per Customer, Customer and product profitability). Because of the introduction of the Mid-Office, which stores all these types of data implicitly and up-to-date in one place, or—if they are stored in a distributed environment—monitors and manages the data elements—all management information (including measures, status and progress) is available to make the appropriate management decisions at the appropriate levels at the appropriate moments. The information is real time available, and any report (including the total profit and loss or the ad hoc annual report) can be pulled from the Mid-Office at any moment in time. Operational management information includes tracking and tracing information of actions and transactions. Since the Mid-Office with its process management function knows the status of any transaction in the organization or the value chain, (this is the only way by which the process manager function can function effectively), this information can be used for operations management (load balancing, capacity planning, exception handling), the Customer service desk answering a Customer query, or even the Customer himself, that may have web-access to their respective transaction and transaction status information.

Multi-channel

All Front Offices are connected to the Mid-Office on a logical one-to-one basis. This means that the Mid-Office system is true multi-channel, something that most organizations can only dream about. The meaning of true multi-channel in this respect is not the point that an organization is present on multiple channels, but that all information is consistent (as in integrity, but also in look and feel) through all channels a Customer may enter. As an example, a Customer can go to the branch of a travel agency, book a hotel at the counter, walk back home, call the hotel and get the reservations desk, which confirms the booking, gets home and finds an e-mail from the hotel confirming the booking and, when surfing on the internet to the hotel site, enters the reservations page and see his reservation in the system. All real time, though different channels. With the Mid-Office system in place, Customers of an organization do not check the information in any Back Office, but only in the Mid-Office (although they do not know they are in fact doing that). Since all channels are also connected to the Mid-Office, it is the Mid-Office information that will be used. Therefore, Back Offices are transparent to the Customer. This is particularly interesting for reasons of consistency, since different Back Offices most likely will have different service levels for processing the same information (the travel agency may process the reservation right away, the hotel only overnight). Because also the hotel reservations desk is not more than a channel, all relevant individuals (travel agency, Customer, hotel clerk) do their inquiry in the Mid-Office, not in any Back Office. At the same time, any Back Office (for example planning of hotel room space) will have access to and do inquiries in the Mid-Office and not the respective Back Office. Therefore, all information is consistent and reliable (otherwise, if the hotel clerk would look in the hotel reservation system instead of the Mid-Office, he might see different, i.e. not yet up-to-date information). The way this works is that the information and data known in the Back Offices are kept in sync as much as needed in the Mid-Office. By function of the Mid-Office, the complete and most up to date information (the ‘Truth’) ideally sits in the Mid-Office.

One ‘Window’ and the Global, Consistent and Consolidated View

In a situation without a Mid-Office system in place, usually a Customer, if connected by a very interactive channel like a web-site, looks directly in an organization's Back Office. Since there could be many Back Offices in that organization, each supported by different applications and by different databases, with various types of Customer identification and information, and with different operating timelines (batch, real time, scheduled), such Customer will have to apply different Customer id's and sees inconsistent information. Also, if such Back Offices are located on geographically disbursed locations, a Customer usually has to identify himself differently for each different geographical location, and does not get a consolidated view of what is outstanding with the complete organization, unless he builds up that picture himself. If the Customer interacts through a Customer Service desk, the Customer service employee has the same challenge. Once in the above situation a Mid-Office system is in place, it forms a shell between the channels and the Back Offices, through which the Customer now gets a one, up-to-date, consistent and consolidated view: one ‘window’ into the organization. This would support logical ‘one window’ principles, for instance one relationship manager being responsible for the entire Customer relationship for the worldwide business of the Customer.

Fully Scalable

Any organization could be constraint by the capacity of its information systems. In this way, an organization could grow as large as the capacity of its least performing system supporting its core process. Bringing in new capacity can usually only be done by working together with the system supplier to enhance capacity of the system or to find another system with more capacity. This in itself will bring long timelines (packages selection process, custom development) and systems integration issues. Through the concept of the Mid-Office, where the coordination of Back Offices is done from the Mid-Office,-this problem is easily solved by adding the same application as another instance, possibly but not necessarily on another hardware platform, and have it made known to the Mid-Office. In fact, the organization has just introduced a new Back Office. The Mid-Office process management function can now choose to run the same transaction type through a number of similar yet disparate alternative systems, and still guarantee consistency and data integrity (FIG. 21). By virtue of the information of available capacity, known at any time, the process management function can determine the best way for the transaction to go, allowing enormous scalability opportunities to allow organization (expansive) growth. This concept is quite similar to computer systems management' load balancing. In this way, the organization's capacity is only constraint by the capacity of the process management function, which is extendible by introducing a hierarchy of process management functions, if necessary.

Relatively Low Intrusive Implementation

The introduction and implementation of the Mid-Office is relatively low intrusive, which means that the organization does not need to make huge adjustments in infrastructure. It is therefore faster and cheaper. This is particularly interesting, since in most now-a-days projects, most of the budget is spent on implementation and systems integration, not coding of custom systems or software licenses for packages purchased. The Mid-Office works together with any legacy in the organization and does not provide lock-in with any vendor that is used as a supplier of components to the Mid-Office. In fact, the Mid-Office can be seen as a ‘black box’, that unlocks the potential in the organization by making legacy more effective in order to help the organization to do more with the systems they have. Relatively low intrusive does not equal low impact though. The effect on the organization could be enormous. If the organization decides it wants to cash all benefits of the Mid-Office system and the surrounding services, it should at least give itself the chance to restructure along process lines instead of functional orientation. Although this could mean a (culturally and politically) difficult issue, the benefits of becoming a process based organization is enormous and gives a competitive edge towards non-process based competitors.

Low Maintenance Through Reduced Complexity

Changes in an infrastructure usually give a headache since most applications in an organization are to some extent mutually dependent and the data they share. This is primarily caused by the number of relationships applications mutually entertain. Because of all the interfaces that normally exist in an organization (directly on-line or batch connections, downloads and up-loads, printer output, manual access, or any other form), changes become extremely difficult and risky. What seems to be a minor adjustment to an application can have a big influence for a user downstream, who's information requirement is not recognized but who relies on the information out of the respective source for his own performance, even if this source was not specifically designed for him. Especially in the area of measuring sales performance or Customer information, often users need access to many different systems to build up the pieces of their jigsaw; these are often not sales systems but purely operational systems. An environment like this is hard to maintain, since sometimes documentation lacks of the usage of software applications in most cases documentation certainly lacks for the ‘secondary usage’ of these applications. Since the Mid-Office reduces the interfaces to a one-to-one connect between an application and the Mid-Office environment, changes are far more easily effectuated. Also, the Mid-Office knows exactly the flow of data in the organization, since it logs all usage of information. Based on this, the Mid-Office can also determine what the best time is for application adjustment and could propose detours in order to obtain the same information for other users during the specific application downtime. As a summary of the system features described in this section, FIG. 22 summarizes the benefits of a Mid-Office system implementation for an organization.

The Mid-Office System Seen Within the Business Context

If confronting the Mid-Office system with the business context as described in the introduction, we find that the Mid-Office system supports globalization; this is because both Front Offices and Back Offices are connected to the Mid-Office system in a fully geography independent way. The Mid-Office system will consolidate all information from all (regional) Back Offices, thus showing to a Customer the full global picture through any channel, including but not limited to web browsers and mobile phones. The information will be consistent, the content up-to-date and the representation will have the same look-and-feel when approached from whatever location; also the processes will be consistent with each other and through time, since there is only one global coordination mechanism.

Industry consolidation, including cross-border mergers and acquisitions are fully supported by the implicit system integration facility of the Mid-Office system: the new partner/subsidiary will be connected immediately as the total chunk, and only later will be improved through opening the black box and connect the Mid-Office system to what really matters inside the black box. Of course, outsourcing and the formation of partnerships and integrated/extended value chains are accommodated as well by this easy integration facility.

By the capability for delivering fast time-to-market for new products and markets the Mid-Office system allows organizations to cope with reducing business cycles and product/market life-cycles: it offers implicit rapid innovation power and the ability to change course quickly. Because of the fast and therefore cheap time-to-market, as well as changing process flows as simple as changing business rules in a data base, mass-customization is rather a characteristic than a challenge for the Mid-Office system. Because Back Offices only need to focus on production and not on Customer taste or peak variety, they can be stable and efficient, and also highly scalable by adding identical functionality without limitations. This solves the controversy between mass-customization, economies of scale and economies of scope.

The Mid-Office system copes with the disadvantages of specialization by always keeping the big picture in mind. Every process has its place in the total set of enterprise architectures. Organizations with a Mid-Office system in place can become the new leaders, since they have the information about and the ability to influence their direct and indirect environment.

The Mid-Office system supports both dis-intermediation and re-intermediation trends: it can cope with dis-intermediation since it can serve numerous of different clients and client segments by connecting the organization's own Back Offices in a multi-channel and scalable way; it can cope with re-intermediation since it offers the perfect platform to connect all suppliers (becoming external Back Offices to the mechanism) to all Customers.

### SUMMARY OF THE INVENTION

Organizations need an enterprise architecture to operate and change in a planned way. The business process is the key element in the enterprise architecture. The business process shows the relationship between what the organization does (operations and tactics) and what it wants to do (strategy). It also aligns all the factors that are guiding and/or supporting an organization: management, procedures, environmental constraints, people, information technology and communication systems, facilities, etc. By arranging the Business Architecture of an organization or a set of organizations to the FMB concept and subsequently all other architectures of the organization to the FMB4 framework, organizations can become very effective, efficient, flexible and manageable. Creating this FMB4 architecture is an also a key condition for a successful implementation of the Mid-Office system—the physical component of the invention. Implementation of the Mid-Office system based on the FMB4 framework in an organization means a profound professionalization of that organization. Application of the Mid-Office system reduces the number of relationships in an organization from N*M to N+M, thereby allowing for improved manageability and maintainability and ease and speed of implementation. The analogy with a computer processor comes to mind, which makes a computer run faster, more efficiently, and in improved multi-tasking mode. The Mid-Office system is not a computer processor but, in fact, an organization processor. By putting the Mid-Office ‘organization processor’ in place, organizations become more effective and better performing organizations (meeting or exceeding Customer requirements, including speed of fulfillment), efficient organizations (fully aligned functions, no waste, no obsolete functions, no counter-productivity or sub-optimization), adaptive organizations (fast time-to-market for new markets, products and processes; fast integration with [out-source] partners, mergers and acquisitions) and highly manageable and measurable organizations (real-time and accurate management information at any level and the ability to take action immediately) with automatic quality assurance capabilities; they become highly effective organizations that will have the ability to sustain by a major competitive advantage in an increasingly competitive world.

The key discriminating factor of the current invention is therefore not the separate components of which it will be built. It is using those different existing technology components that are (near) best-of-breed at a given time—respecting their functioning and all patents pending on those technologies and supportive inventions—and put them together in a specific composition in a revolutionary ‘Mid-Office black box’ in order to leverage a far better result in that specific composition than the combined individual power of each of the automated functions and/or software and/or hardware components by itself and subsequently put this composition to work in innovative architectures based on the FMB concept and the FMB4 framework.

[image]

[image]

[image]

[image]

I claim:

1. A concept and method for organizing and aligning processes, functions, roles and tasks within organizations and across organizations by dividing these into:
Front Offices covering all processes, functions, roles and tasks whereby only the interaction with any outside party, including Customers, is involved,
Back Offices covering all processes, functions, roles and tasks whereby only the execution of a service or the production of a product is involved,
characterized in that
between the Front Offices and the Back Offices a Mid-Office is introduced covering all processes, functions, roles and tasks related to the coordination and management of all processes, functions, roles and tasks within or across organizations over all relevant Front Offices and Back Offices as well as centrally storing and/or managing all relevant data and information about organizational internal and organizational external objects and occurrences necessary for effective management and proper performance of said organization processes, functions, roles and tasks,
for the main purposes of reducing complexity of relationships—and therefore reducing management complexity—and increasing flexibility for change.

2. A framework and method for implementing the concept and method defined in claim 1, said framework consisting of the following four architecture layers or blueprints:
a first architecture layer or blueprint describing the processes, functions, roles and tasks within or across organizations, aligned with the objectives of these organizations,
a second architecture layer or blueprint describing the information flows and data elements necessary to support the above mentioned processes, functions, roles and tasks,
a third architecture layer or blueprint describing the applications and/or software systems/components necessary to support the above mentioned processes, functions, roles and tasks and supporting information flows and data elements,
a fourth architecture layer or blueprint describing the hardware systems, operating systems and networks necessary for the aforementioned applications and software systems to run on,
characterized in that each of the above-mentioned four architecture layers is constructed according to the concept and method defined in claim 1.

3. The framework and method of claim 2, whereby the four architecture layers or blueprints form one set with each other such that the corresponding areas of the concept and method as defined in claim I are aligned: Front Offices to Front Offices, Mid-Office to Mid-Office and Back Offices to Back Offices, for the main purposes of creating a consistent framework to support organization improvement and change and/or in order to implement the concept as defined in claim 1 within or across organizations.

4. The framework and method of claim 2 and 3 whereby all four architecture layers or blueprints are still to be seen independent of each other to obtain and maintain maximum flexibility to change any of the components in any of the architectures without substantially affecting the other components in any of the architecture layers or blueprints, or any of the architecture layers or blueprints themselves.

5. A system being the materialization and operationalization of the Mid-Office part of the framework defined in claim 2 through 4 and therefore covering all Mid-Office components on the third and fourth physical layers of the framework, designed for the purpose of implementing in an automated environment the concept and method defined in claim 1 as well as the framework defined in claim 2 through 4, said system comprising an integrated software/hardware platform together performing the various coordination, management, data and information management processes, functions, roles and tasks assigned to the Mid-Office, which system does not contain any Front Offices and Back Offices other than for its own management, maintenance and development and therefore is generic and applicable to any organizational environment.

6. The system of claim 5 comprising of various software components of which the key components are:
a process management software component or a detailed workflow component that routes actions and/or transactions initiated outside the system (Customer or third party initiated) or inside the system (triggers such as time or another event) through the end-to-end process life-cycle for that action and/or transaction by means of translating the process steps into business rules and following the business rules in order to call the different Back Offices as steps in the whole process by giving them the desired input for processing and expecting the proper output after processing according to predefined service level agreements between the process management software component and the various Back Offices;
a rule base containing business rules that are the translation of the process steps of the processes that take place within or across the organizations in focus in order for the process management software component to function and to manage and coordinate the processes to be executed;
a data base and/or administration that contains the exact status of actions and or transactions flowing through the processes; this data base and/or administration is capable of distracting, compiling and consolidating data and information in order to provide any relevant stock balance or total action and/or transaction status as well as optionally links to other Mid-Office external data bases in order to keep the transaction status data base in the Mid-Office in sync with all relevant Mid-Office external transaction status data bases by means of substitution, duplication, replication, remote access or any other means of keeping data bases synchronized on a when necessary basis;
a data base or a set of databases containing static data and/or all relevant organizational internal and organizational external data, including links to other Mid-Office external data bases and mechanisms in order to keep the static data base in the Mid-Office in sync with all relevant Mid-Office external data bases by means of substitution, duplication, replication, remote access or any other means of keeping data bases synchronized on a when necessary basis.

7. The system of claim 5 and 6, optionally with the extension of the relevant hardware components and operating systems necessary for the above software components, functions and databases to run on if not available in the organization where the system will be implemented.

8. The system of claim 5 and 6, optionally containing a software component carrying out system management tasks, including but not limited to exception handling, recovery and error recovery, time management, check pointing, load balancing, logging and restart capabilities for the whole mechanism, including Front Offices, Mid-Office and Back Offices.

9. The system of claim 5 and 6, optionally containing a middleware component connecting in a standard way all software components, functions, databases, operating systems and hardware and network components contained in the system, as well as supporting open connectivity from the system of claim 5 and 6 to any organization Front Office and/or Back Office for easy integration of the system in any organizational context or existing and/or future infrastructure.

10. The system of claim 5 and 6, optionally containing a data base that contains all historic, log and archived data about the system, its content, its configuration and its behavior at any given time.

11. The system of claim 5 and 6, optionally containing a software component carrying out technical channel management tasks in order to monitor, manage and report on channel behavior for the whole mechanism, i.e. all channels that connect all Front Offices, Mid-Office and Back Offices.

12. The system of claim 5 and 6, optionally containing a software component carrying out security tasks which are Front Office and Back Office independent, supporting the generic character of the Mid-Office, including but not limited to authentication, authorization, transaction security and encryption/decryption, with the purpose of allowing only authorized parties to do authorized actions as well as to manage integrity of all data, including safeguarding privacy and the proprietary nature of data and information.

13. The system of claim 5 and 6, optionally containing a software component carrying out Customer relationship management tasks, including monitoring, managing and reporting on Customer behavior, Customer profitability and Customer profiles.

14. The system of claim 5 and 6, optionally containing a software component carrying out human resources management tasks in order to monitor, manage and report on human resources behavior, including skills and experiences and mapping these to processes, functions, roles, tasks, jobs and responsibilities.

15. The system of claim 5 and 6, optionally containing a software component carrying out stakeholder relationship management tasks in order to monitor, manage and report on behavior, contracts, agreements, expectations, flows, statuses, performance measures and all other relevant data for all organization stakeholders, including but not limited to owners, suppliers, (strategic) partners, governments and other public or contextual bodies and communities.

16. The system of claim 5 and 6, optionally containing a software component carrying out administration and financial administration tasks in order to monitor, manage and report on stock balances, including financial balances, and translating all stock balances into financial balances as well as to support monitoring, managing and reporting on risks and exposures;

17. The system of claim 5 and 6, optionally containing a software component carrying out content management tasks in order to monitor, manage and report on information from various sources in various media and various formats.

18. The system of claim 5 and 6, optionally containing a software component carrying out management information and decision support tasks in order to monitor, manage and report on the nature and status of critical success factors (CSF's), key performance indicators (KPI's), performance targets and performance measures of the organization or organizations in focus and to support multi-level decision making by extracting, compiling, consolidating and arranging data.

19. The system of claim 5 and 6, optionally containing data warehouses and data marts to support the management information and decision support software component of claim 18 by rearranging data for security, response time and convenience purposes.

20. The system of claim 5 through 19, embedded in a development environment that allows for functional maintenance of the system, including but not limited to enhancements, change management, versioning, transition of versions and coexistence between versions.
